(19) United States
(12) Patent Application Publication
(10) Pub. No.: US 2015/0010894 A1
(43) Pub. Date: Jan. 8, 2015

(54) System and Method for Authoring and Delivering Online Educational Courses

(71) Applicant: Kahina Morisset, Vancouver (CA)

(72) Inventor: Kahina Morisset, Vancouver (CA)

(21) Appl. No.: 13/936,869

(22) Filed: Jul. 8, 2013

(51) Int. Cl. G09B 5/00

(52) U.S. Cl. CPC G09B 5/00
USPC 434/362

(57) ABSTRACT

A system and method for authoring and delivering online educational courses is disclosed. In at least one embodiment, a central computing system is provided with details related to a desired subject matter for which the course is to cover, a total duration of time allotted for the user to complete the course, and a minimum number of total points required for the user to receive a passing score upon completion of the course. Based on those course-related details, the computing system generates a course structure comprising an at least one instructional unit and learning activity, along with associated user interfaces and allows the developer to selectively populate each learning activity with content and selectively adjust the time duration and points. The system and method for authoring and delivering online educational courses of the present invention also including a variety of delivering features that the developer can employ.

### RELATED APPLICATIONS

Not applicable.

### INCORPORATION BY REFERENCE

Applicant(s) hereby incorporate herein by reference any and all patents and published patent applications cited or referred to in this application.

### BACKGROUND OF THE INVENTION

1. Field of the Invention

Aspects of this invention relate generally to continuing professional education, and more particularly to a system and method for authoring and delivering online educational courses.

2. Description of Related Art

By way of some background, e-learning has become an increasingly popular educational method, especially for persons seeking higher education, continuing education, or distance learning opportunities. The extent to which e-learning assists or replaces other learning and teaching approaches is variable, ranging on a continuum from none to fully online distance learning. Additionally, these online courses may range on a continuum from fully controlled by a teacher to fully self-directed by each student individually.

A learning management system (“LMS”) is software used for delivering, tracking and managing training and education; for example, tracking attendance, time on task, and student progress. Educators can post announcements, grade assignments, check on course activity, and participate in class discussions. Students can submit their work, read and respond to discussion questions, and take quizzes. An LMS may allow teachers, administrators, students, and permitted additional parties (such as subject matter experts if appropriate) to track various metrics. LMS's range from systems for managing training/educational records to software for distributing courses over the Internet and offering features for online collaboration. The creation and maintenance of comprehensive learning content requires substantial initial and ongoing investments of human labor. Effective translation into other languages and cultural contexts requires even more investment by knowledgeable personnel.

A learning content management system (“LCMS”) is software for author content (courses, reusable content objects). An LCMS may be solely dedicated to producing and publishing content that is hosted on an LMS, or it can host the content itself.

Much effort has been put into the technical reuse of electronically based teaching materials and in particular creating or re-using learning objects. These are typically self-contained units that are properly tagged with keywords, or other metadata and often stored in an XML file format. Creating a course requires putting together a sequence of learning objects. There are both proprietary and open, non-commercial and commercial, peer-reviewed repositories of learning objects such as the Merlot repository.

Sharable Content Object Reference Model (“SCORM”) is a collection of standards and specifications that applies to certain web-based e-learning. In a bit more detail, many e-learning producers use the SCORM specification to structure and package course content into a compressed file (containing the SCORM Content Aggregation Model) which is then uploaded to a server for interoperability with various LMS's that conform to the SCORM run-time environment. The LMS and content communicate through a communication protocol that enables the content portion to send student actions and results to the operating management system which, in turn, renders progress reports and results.

Many large companies and educational institutions have developed their own LMS or rely on proprietary LMS's from major e-learning vendors to host training content for their employees or students. However, many smaller entities (such as non-profit professional organizations) do not have such infrastructure and rarely own a LMS or can bear the service cost of an e-learning vendor. In the field of continuing professional education, numerous training content are authored by independent practitioners and mostly self-published with very little or no LMS capabilities due to the heavy cost of developing and maintaining this type of complex and advanced software-based system.

Certain open source LMS solutions (such as www.moodle.org) have been developed in an attempt to bridge this gap for smaller organizations and independent practitioners by providing a reliable software solution that would otherwise cost thousands of hours of development cost and maintenance. However, these solutions nevertheless require some amount of IT infrastructure to customize and maintain the system due to the lack of standardization of e-learning course development processes.

Additionally, while the SCORM content sequencing model is very sophisticated, it does not promote or enable a simple, consistent standard of e-learning course structure design, thereby leaving too much room for variability which, in turn, unnecessarily increases the costs of development. For example, issues like development of course structure, breakdown in instructional units, sequencing and type of learning activities, collection of subject matter-related resources, learning objectives' assessment strategies are left in the hands of the instructional designer.

Furthermore, training providers and instructional designers who develop continuing education programs bear the responsibility to ensure the training program's time duration estimates are sufficient and that the units mentioned on the associated training certificates awarded to successful students reflect both the achievement of a learning goal 35 and an accurate estimated time of study to reach that goal. However, in the current state of the art of e-learning, time estimating techniques are not standardized and so vary from one system to another, one company to another, and even one designer to another. Such a lack of standardization is a major concern for professional organizations since this can result in significant discrepancies between training programs, allowing some professionals to easily fulfill training requirements by utilizing a training program that does not meet qualitative expectations in terms of educational value and learning goal 35 achievement. For example, many designers traditionally use a “time-per-screen” estimate based on their expert judgment or historical data. They take into account parameters that are quantifiable such as number of words per screen and average speed of reading or time to play a video. But it becomes more complex when it comes to measuring learning time to complete an interactive learning activity. For example, one click on a button—such as to answer a quiz question—could take ten seconds or thirty seconds to answer, depending on the gap of knowledge and/or skill currently possessed by a given student. E-learning courses must attempt to account for this time during the design phase, even before any students have taken the course.

Thus, there remains a need for a way to author and deliver online educational courses that is flexible enough to accommodate most instructional design needs while also providing a sufficiently defined structure such that enables any type of course to be developed with consistency and at relatively limited cost. Aspects of the present invention fulfill these needs and provide further related advantages as described in the following summary.

### SUMMARY OF THE INVENTION

Aspects of the present invention teach certain benefits in construction and use which give rise to the exemplary advantages described below.

The present invention solves the problems described above by providing a system and method for authoring and delivering online educational courses. In at least one embodiment, a central computing system is configured for receiving and processing data related to an at least one online educational course along with an at least one user. Using a computing device in communication with the computing system, the computing system is provided with details related to a desired subject matter for which the course is to cover, a total duration of time allotted for the user to complete the course, and a minimum number of total points required for the user to receive a passing score upon completion of the course. Based on those course-related details, the computing system automatically generates a course structure comprising an at least one instructional unit, along with associated user interfaces. The computing system also automatically generates an at least one learning activity for each instructional unit, with each learning activity providing a focus section, an observation section, an experimentation section, an exploration section, a creation section, a sharing section, and an evaluation section. Additionally, each section has a duration of time allotted for the user to complete said section and a maximum number of points to potentially be earned by the user for completing said section. The developer is subsequently able to selectively populate each section of each learning activity with content associated with the subject matter of the course. Additionally, the developer is able to selectively adjust the duration of time and points associated with each section of each learning activity.

A primary objective inherent in the above described system and method of use is to provide advantages not taught by the prior art.

Another objective is to provide such a system and associated methods that are capable of providing a means to author and deliver online educational courses that is flexible enough to accommodate most instructional design needs while also providing a sufficiently defined structure such that enables any type of course to be developed with consistency and at relatively limited cost.

Another objective is to provide such a system and associated methods that allow subject matter experts themselves to author online educational courses without the assistance of an instructional designer.

Other features and advantages of aspects of the present invention will become apparent from the following more detailed description, taken in conjunction with the accompanying drawings, which illustrate, by way of example, the principles of aspects of the invention.

It will be appreciated by those skilled in the art that the exact configuration of the system and associated methods may take a number of forms to suit particular applications without departing from the spirit and scope of the present invention. Accordingly, it will be further appreciated that the configuration of the system shown and described is exemplary and that the invention is not so limited.

### BRIEF DESCRIPTION OF THE DRAWINGS

The accompanying drawings illustrate aspects of the present invention. In such drawings:

FIG. 1 is a simplified schematic view of an exemplary system for authoring and delivering online educational courses, in accordance with at least one embodiment;

FIG. 2 is an architecture diagram of an exemplary online educational course, in accordance with at least one embodiment;

FIG. 3 is an architecture diagram of an exemplary learning activity, in accordance with at least one embodiment;

FIG. 4 is an exemplary illustration of an Internet browser or similar application window depicting an exemplary user interface, as displayed by an exemplary computing device, in accordance with at least one embodiment;

FIGS. 5 and 6 are flow diagrams of an exemplary method for authoring and delivering online educational courses, in accordance with at least one embodiment; and

FIG. 7 is an exemplary illustration of an Internet browser or similar application window depicting an exemplary developer interface, as displayed by an exemplary computing device, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION OF THE INVENTION

The above described drawing figures illustrate aspects of the invention in at least one of its exemplary embodiments, which are further defined in detail in the following description.

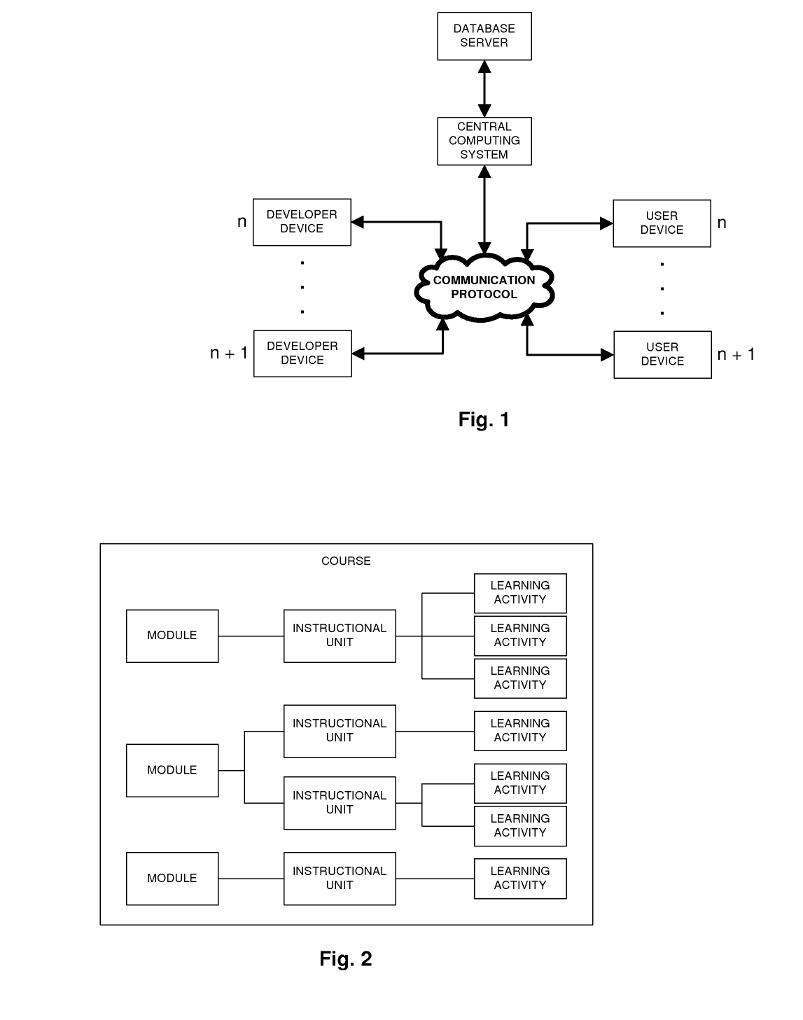

Turning now to FIG. 1, there is shown a simplified schematic view of an exemplary system 20 for authoring and delivering online educational courses, in accordance with at least one embodiment. The system 20 provides, in at least one embodiment, a central computing system 22 configured for receiving and processing data related to an at least one online educational course (hereinafter, “course”) 24 along with data related to an at least one user, an at least one user device 26 in selective communication with the computing system 22, and an at least one developer device 28 also in selective communication with the computing system 22. Additionally, in at least one embodiment, a database server 30 is in communication with the computing system 22 and configured for selectively storing said data related to the at least one course 24 and at least one user.

At the outset, it should be noted that the means for allowing communication between each of the computing system 22, at least one user device 26, at least one developer device 28, and database server 30 may be any wired- or wireless-based communication protocol (or combination of protocols) now known or later developed. As such, the present invention should not be read as being limited to any one particular type of communication protocol, even though certain exemplary protocols may be mentioned herein for illustrative purposes. It should also be noted that the terms “user device” and “developer device” are intended to include any type of computing device now known or later developed, such as desktop computers, smartphones, laptop computers, tablet computers, etc.

With continued reference to FIG. 1, in the exemplary embodiment, the computing system 22 contains the hardware and software necessary to carry out the exemplary method for authoring and delivering online educational courses 24 as described herein. Furthermore, in at least one embodiment, the computing system 22 comprises a plurality of computing devices selectively working in concert with one another to carry out the exemplary method for authoring and delivering online educational courses as described herein. The at least one user device 26 is in the possession of an at least one user (or student) who is desirous of completing the at least one course 24 provided by the system 20. The at least one developer device 28 is in the possession of an at least one developer (or educator) who is tasked with authoring the at least one course 24 to be provided by the system 20. In the exemplary embodiment, as discussed further below, the user devices 26 and developer devices 28 access the courses 24 via a website portal hosted by the computing system 22 and/or database server 30, with the content of the courses 24 being selectively displayed on the respective screens of the user and developer devices 26 and 28.

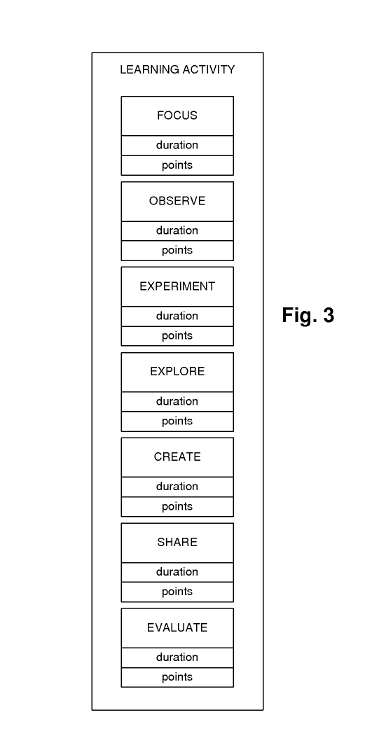

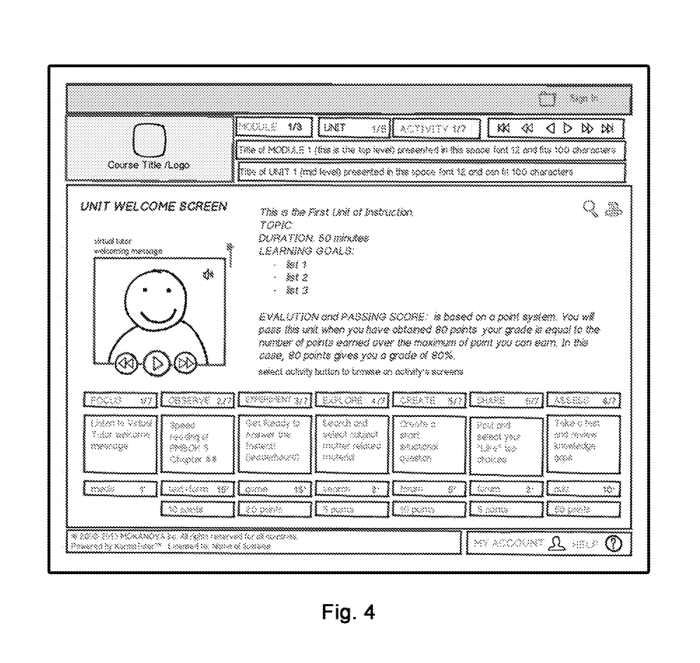

In the exemplary embodiment, as illustrated in the architecture diagram of FIG. 2, each course 24 preferably comprises a 3-level hierarchical structure. In a bit more detail, in at least one embodiment, each course 24 is comprised of an at least one module 32 designed to guide a target audience of users to reach a pre-defined level of proficiency in a particular area of knowledge and/or skill. Each module 32 is comprised of an at least one instructional unit 34 designed to provide a balanced breakdown of the course 24 subject matter by conveying a specific learning goal 35 associated with said course 24 subject matter. Each instructional unit 34 is comprised of an at least one learning activity 36 designed to help convey the specific learning goal 35. Specifically, as illustrated in the architecture diagram of FIG. 3, in at least one embodiment, each learning activity 36 is comprised of seven discrete sections: a focus section 38, an observation section 40, an experimentation section 42, an exploration section 44, a creation section 46, a sharing section 48, and an evaluation section 50.

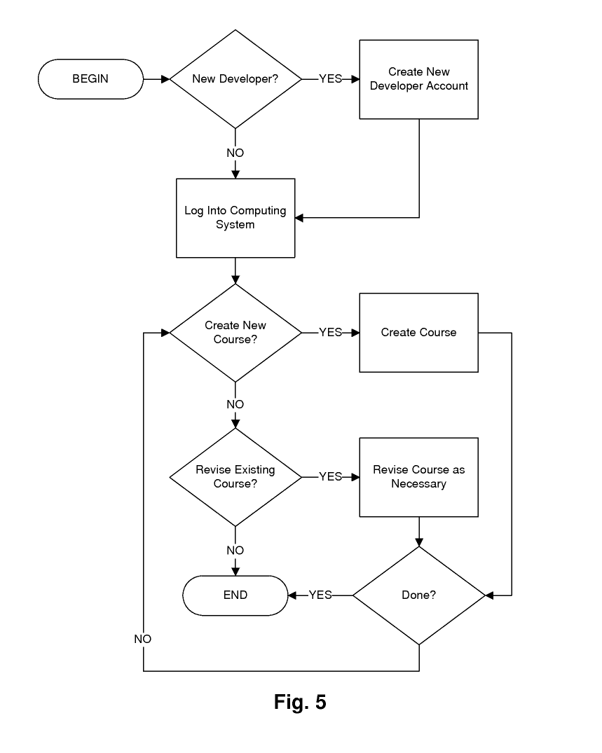

With reference to FIG. 4, which shows an exemplary illustration of a user interface 52, in accordance with at least one embodiment, as displayed via an Internet browser or similar application window on the screen of the user device 26, the focus section 38 provides the user with information about key points of the learning objectives intended to be conveyed to the user through the associated learning activity 36, along with expected levels of proficiency and how performance is to be reported by the computing system 22. In the exemplary embodiment, the information is provided as a combination of audio and visual components, including but not limited to videos, audio files, text and related graphics. The observation section 40 provides the user with a short presentation, preferably audio narrated via text-to-speech, designed to convey the topic or subject matter of the associated learning activity 36. In other words, the observation section 40 conveys or teaches the desired subject matter to the user. In the experimentation section 42, the user is provided with self-assessment tools designed to test the user's understanding of the subject matter conveyed in the observation section 40 and provides immediate feedback to ensure proper understanding of that subject matter has been attained. For example, in at least one embodiment, the experimentation section 42 provides questions to be answered by the user, or concepts that must be matched with their definitions. Additionally, in at least one embodiment, the user is allowed an unlimited number of attempts until the observation section 40 is correctly completed. In another embodiment, the experimentation section 42 provides terms for which the user must, in turn, provide written definitions in their own words. Once the user has completed and submitted their written response, the system 20 provides a standard definition (or a short summary) prepared by the developer and displays an interactive evaluation form to guide the user through conducting an honest observation of their work and compare with a list of evaluation items prepared by the developer. For example one criteria could be how comprehensive the summary was (i.e., whether all expected concepts and important keywords are presented, number and type of examples, etc.). When the user has answered all the questions about their observations by comparing their answer(s) to the standard answer(s), they can then submit their answer(s) at which point the system 20 will compute an overall score based on their answer(s). In such a scenario, the score is not computed with direct answers from the user (like in a quiz), but rather based on how the user has self evaluated their own performance with specific criteria. Thus, this is a self-evaluation tool since the system 20 is assisting the student in observing and assessing the quality of their work and performance based on pre-established expected achievement criteria. Such self-evaluation tools enable developers and subject matter experts to design and develop evaluation and experiment activities that are more than simply quizzes having a discrete selection of correct answers, and instead more elaborate activities such as summary, essay or story writing without the cost of having an online tutor reviewing users' work. In this way, users can continue progress in their learning without having to wait for a tutor to review their summary, essay or story. The system 20 can also allow sharing of such users' material as designed by the developer so users have more opportunities to get a sense of where their performance compares to others and where they stand in their skills training.

In the exploration section 44, the user is given a specified period of time in which to explore the Internet, via the user device 26, in order to search out content related to the subject matter of the learning activity 36. For example, in at least one embodiment, the exploration section 44 requires the user to search out others' views about the subject matter. In the creation section 46, the user is tasked with creating a specified type of content in order to demonstrate their understanding of the subject matter. For example, in at least one embodiment, the creation section 46 requires the user to write, via the user device 26, a short explanation of the subject matter in their own words. In the sharing section 48, the user is given the opportunity to share their created content with other users of the system 20, and to also provide and receive feedback related to such content. For example, in at least one embodiment, the sharing section 48 allows the user to post their created content to a central forum provided by the computing system 22 and accessible to other users enrolled in the same course 24. In at least one embodiment, the sharing section 48 also requires the user to provide feedback on content shared by a specified number of other users. Finally, in the evaluation section 50, the user is required to take an exam designed to assess the user's degree of mastery of the subject matter of the learning activity 36. In at least one embodiment, the evaluation section 50 also provides the user with an opportunity to self-assess their learning performance.

With continued reference to FIGS. 3 and 4, each of the sections 38-50 has a specified duration 54 (i.e., amount of time afforded to the user to complete the section 38-50) and number of points 56 (i.e., maximum number of points 56 available through completing the associated section 38-50), as defined by the developer of the course 24. With respect to duration 54, in at least one embodiment, each section 38-50 of a learning activity 36 has a duration 54 ranging from one to forty minutes, as that amount of time has been found to fall within a recognized “best window” of time for optimum adult learning capacity. As such, the total time or duration 54 for each discrete instructional unit 34 tends to range anywhere from fifteen minutes to three hours—though, the total time would ultimately depend on the aggregated durations 54 of each section 38-50 of each learning activity 36 within that instructional unit 34. Similarly, the total time for each discrete course 24 ultimately depends on the aggregated durations 54 of each section 38-50 of each learning activity 36 of each instructional unit 34 of each module 32. It should be noted that, for courses 24 having a relatively short total duration 54 (such as an hour, for example), the “module” level may be omitted such that the course 24 simply comprises one or more instructional units 34 each comprising one or more learning activities 36. Furthermore, in at least one alternate embodiment, one or more of the above discussed seven sections 38-50 may be omitted or re-ordered as necessary in order to better suit the teaching/learning of a particular subject.

Because the system 20 utilizes a combination of points 56 and durations 54, the result is a workable solution that promotes more educational value and conforms to international continuing educational practices. This improved unit of measurement significantly improves the system's 20 ability to provide tools to course developers to correlate study effort, time spent and learning goal 35 achievement in a more workable and accurate way. From the perspective of a user taking a course 24 designed with the system 20, the experience of learning is enriched and provides instant reporting of the user's progress with respect to the two parameters (i.e., the unit of duration 54 and the unit of points 56). From the perspective of the professional organization and/or developer, they will benefit from more visibility on the actual educational value of a training program rather than only a single measure of the time spent learning/studying. This two-parameter method is also flexible from a user perspective and enables more sophisticated expert judgment related to estimating the value of an educational learning activity 36. For example, two learning activities 36 that possibly could require the same amount of time to complete but that are engaging users learning at different levels can now be accounted for in a different way (by virtue of the respective points 56 awarded based on degree of difficulty), still keeping the unit of time or duration 54 as a point of reference. Another problem that is solved with this new two-parameter method is the ability to value differently and reward differently first and second (or further) attempts at correctly completing tests and quizzes during the experimentation and evaluation sections 42 and 44 of a learning activity 36. In a bit more detail, in at least one embodiment, different amounts of points 56 are awarded to a user who answers a question correctly on their first attempt as compared to a user who answers a question correctly on their second or further attempt. Such flexibility in differentiation is critical for recognizing the variability of the learning goal 35 achievement, as most computerized tests and quizzes have limited pools of questions and successes at subsequent attempts do not accurately correlate to learning goal 35 achievement (since the user is possibly answering correctly simply because they have seen the question before, rather than truly knowing the answer based on their understating of the subject matter being tested).

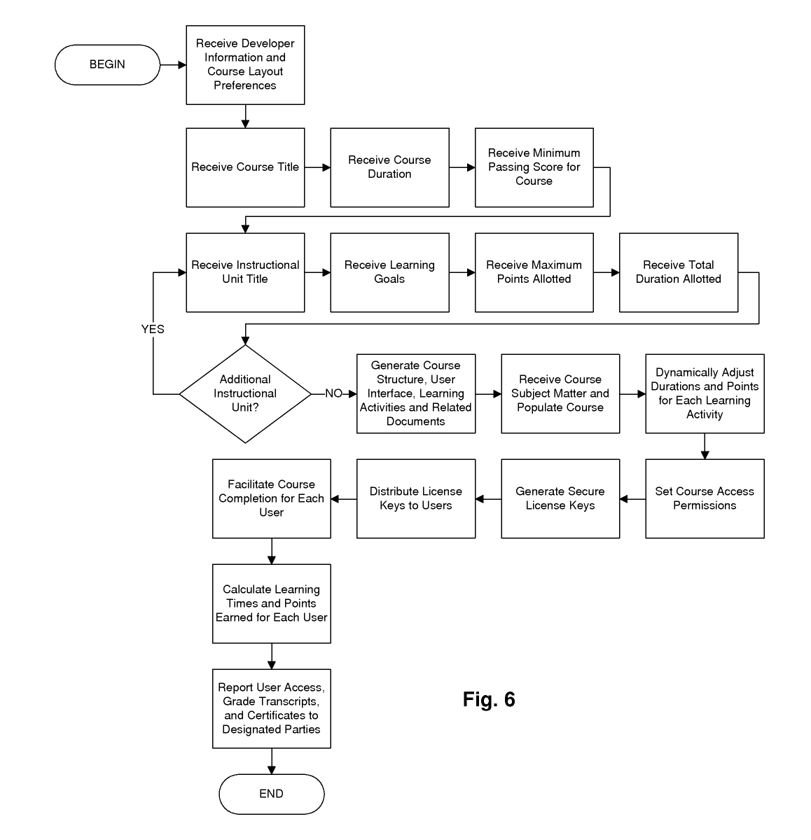

Referring now to the flow diagram of FIG. 5, in at least one embodiment, if the developer is new to the system 20 (502), they must first properly register with the system 20 by creating an account via the developer device 28 (504). Once they have an account with the system 20, the developer is able to log into the computing system (506)—again, using the developer device 28—and create a new course 24 (600). It should be noted that the developer also has the ability to revise any courses 24 that they may have previously created using the computing system 22 (508).

As illustrated in the flow diagram of FIG. 6 and the exemplary user interface 52 of FIG. 4, in at least one embodiment, when creating a new course 24 (600), the developer first provides to the computing system 22 desired developer-related information including but not limited to developer name, company logo, copyright information, preferred color scheme, etc. (602). The developer also provides to the computing system 22 a title 58 of the new course 24 (604), the desired total duration 54 of the course 24 to be allotted (606), and the minimum number of total points 56 required for a user to receive a passing score (608). After providing this general course 24 information, the developer then provides to the computing system 22 a title 60 of a given instructional unit 34 of the course 24 (610), along with the desired learning goal(s) 35 (612), the maximum number of points 56 to be potentially earned by the user at one or more proficiency levels (614), and the desired total duration 54 allotted for the user to complete the instructional unit 34 (616). In at least one embodiment, the computing system 22 also allows the developer to choose the types of learning activities 36 to be offered as part of the instructional unit 34. For any additional instructional units 34 the developer may choose to include in the new course 24 (618), steps 610-616 are repeated appropriately.

Once the developer has finished inputting data related to instructional units 34 for the new course 24, the computing system 22 automatically generates the entire course structure and appropriate user interfaces 52 (620), including but not limited to welcome screens 62, course navigation functionality 64, template screens and placeholders for developer-provided content 66, grading transcripts, and a course completion certificate. In at least one embodiment, the computing system 22 also generates learning activities 36 that are composed of predefined sets of learning interactions sequenced to provide a satisfying learning experience to users with opportunities for focusing, observing, exploring, experimenting, creating, sharing and evaluating. Such learning activities integrate instructional design best practices and are designed to enable users' intrinsic motivation and engagement in order to facilitate the acquisition of new knowledge and skills geared toward specific objectives. These learning activities 36 are non-subject matter specific and provide powerful tools for developers to create text-only engaging and efficient learning experiences in their field of expertise in full autonomy without the help of an instructional designer, a programmer, or a graphic designer.

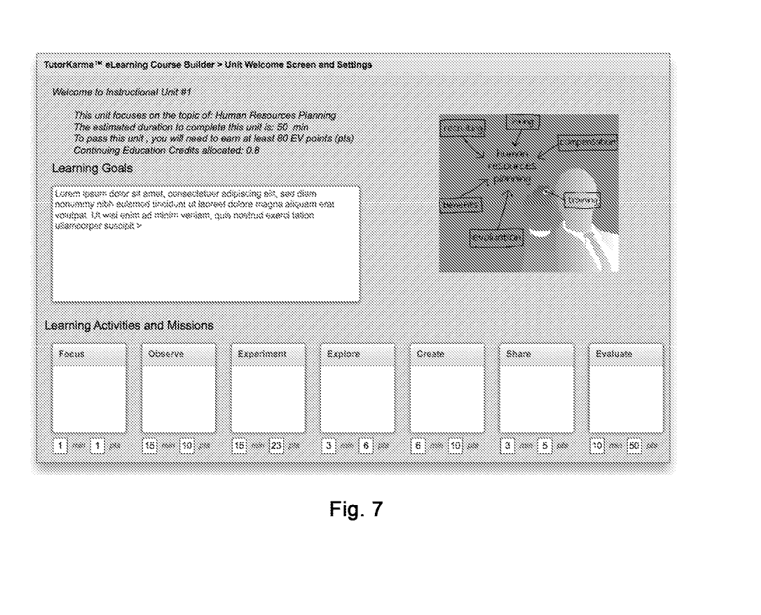

With the barebones course 24 now generated, the developer is able to upload and populate the course 24 with content 66 derived from their own collection of information and related resources associated with the course 24 subject matter (622). The developer is also able to selectively customize activity forms and templates as needed and provide assessment content. An exemplary illustration of a developer interface 68, in accordance with at least one embodiment, as displayed via an Internet browser or similar application window on the screen of the developer device 28 is shown in FIG. 7. The computing system 22 also preferably provides convenient tools for the developer to create both alternate levels of learning activities 36 and user self-evaluation tools. Users can self-evaluate their knowledge and skills gaps and choose the most realistic and rewarding learning scenario. Self-evaluation is a cost saving vehicle for the developer and makes it possible to author a course 24 that is flexible and adapted for a mixed audience using a set of assumptions. More specifically, a developer may want to customize special versions of its course to meet a specific audience needs or respond to market demand with for example limited or extended features. One example is a version with limited features that can be offered as a free demo where most activities are disabled/invisible and only a few activities are available for allowing the user to try/evaluate the course. Another example is where the developer needs to create multiple versions of a particular course in order to address the needs of different audiences having different proficiency levels. Each such version may include a set of different learning activities designed for achieving an appropriate level of proficiency such as “basic,” “intermediate,” “advanced,” etc. In such a scenario, rather than requiring the developer to duplicate the entire course for each version as a starting point, the system 20 enables authoring and delivering of various paths and alternate activities (i.e., multiple versions) from one single course structure. This enables developers to define what are common assets and what are not, then enabling authoring of variations (i.e., alternate learning activities, different quiz questions, different course titles, etc.). In this way, all common assets in need of maintenance are able to be updated only once, rather than for each discrete version. Additionally, developers are able to see at a glance and in context each variation with a simple version switch button, allowing for easy review and comparisons. Thus, the system 20 presents the appropriate learning path to each user depending on their prior level of proficiency and learning goals without confusing them with seeing too many activities or figuring out which ones are optional or which ones are mandatory. This can be achieved with either an open access or a closed access and, with using self-assessment pre-test tools or, license key programming—whichever works best for the developer's market. In the open access, the system 20 provides access to each version of the course, prompting the user with a self-assessment pre-test and analyzing the user's answers to provide a recommendation for the optimal learning path/course version. Users can then select the one path they want to take. Alternatively, in a closed access scenario, specific license keys are generated for each proficiency level achievement, thereby enabling only one learning path among the possible course versions for each user.

With the course content 66 completed, the developer is able to dynamically adjust durations 54 and points 56 associated with each section 38-50 of each learning activity 36 (624). This allows the developer to selectively give more or less weight to reward activities that the course provider wants to value more or less. It is therefore possible to award certificates of completion for users who achieve a general level of proficiency or a higher level of proficiency using the same course 24 and content 66 without the need to develop a new course 24. Additionally, providing alternate and various types of learning activities 36 enables users to achieve one level or another for each learning goal 35. Learning time (i.e., duration 54) could also be understood as the time spent by a user to acquire the knowledge and skill that is being tested. The reality of professional development is that users come from various backgrounds; so while some users will take more time because the subject matter is new to them, others will complete the course 24 relatively quickly and spend relatively less time to complete the learning activities 36. The time spent by a given user in front of his computer rarely coincides with the time spent actually learning the subject matter, given the many distractions a user may encounter (i.e., phone calls, restroom breaks, etc.)—each of which can interfere with the time tracking. Furthermore, many users learn from colleagues, from reading magazines, from participating in the life of their professional community, etc. Thus, where a user is already well versed in new ways to approach a professional issue, he or she will typically take relatively less time to earn more points 56 and complete the course 24 faster. In such a scenario, the learning time required to complete the course 24 is less than the learning time contemplated by the developer of the course 24; but the user has arguably used the entire contemplated learning time if one were to factor in both the time it took the user to complete the course 24 and the time spent learning the subject matter in their everyday interactions prior to actually taking the course 24. But this becomes difficult to assess in a manner that is fair to both users and course providers. Therefore, a developer who creates a course 24 will be able to use self-evaluation tools and alternate learning scenarios to address the needs of a mixed level of proficiency of their target audience of users. In this way, the developer is able to more accurately adjust the duration 54 of a given learning activity 36 to reflect the amount of time an appropriate user would reasonably require to complete that learning activity 36. This will reward all individual initiatives and self-motivated learning and provide a fair assessment method of how a user has fulfilled their continuing education requirements.

Once the developer has dynamically adjusted durations 54 and points 56 associated with each learning activity 36, the course 24 is essentially ready to be made available for users to take. To do so, the developer sets access permissions in order to limit the availability of the course 24 to only those users whom the developer specifies (626). It should be noted that, in at least one embodiment, the developer may optionally choose to make the course 24 publicly available to any user of the system 20. The computing system 22 then generates a set of secure license keys for the course (628) and distributes them to the designated users (630). This enables the developer to work with third parties to provide access to the course 24 with no need for advanced technology API or system integration. With the license keys distributed, each designated user is then able to log into the computing system 22 via their user device 26 in order to complete the course 24 (632)—typically at their own pace. In the exemplary embodiment, users are able to self-evaluate their proficiency level at the beginning of each learning activity 36 and choose the most realistic and rewarding path for them. Upon completing a learning activity 36, the computing system 22 dynamically calculates the user's learning time (i.e., duration 54) and points 56 earned (634), and also provides the user with real-time performance information so that they know how well they are doing and what more is required in order to pass the course 24, or simply the instructional unit 34.

Upon completing the course 24, the computing system 22 transmits reports regarding user access, grade transcripts and certificates to any parties who have been designated to receive such information (636). The computing system 22 is also capable of displaying special mentions on the delivered certificates to report the actual educational value attained from one user to another. Such special mentions can be customized and used by professional organizations as a way to change their standard requirement of continuing education, making more specific requirements with not only units of duration 54 but also with units of educational value (i.e., points 56) attainment, as a way of promoting higher standards. Thus, the certificate of course completion preferably displays in real-time where a user stands in terms of learning duration 54 and points 56 earned and proficiency level reached. This process is particularly well adapted to continuing education for professionals who are looking to develop their skills in areas of interest and earn the amount of credit to fulfill their professional organization requirements. It should also be noted that users' tracking of activities is limited to the final performance report so as to create a non-controlling atmosphere where privacy of the user is more respected, which is conducive of a relaxing and thus more efficient learning experience (and also reduces the cost of data storage requirements).

To summarize, regarding the exemplary embodiments of the present invention as shown and described herein, it will be appreciated that a system and method for authoring and delivering online educational courses is disclosed. Because the principles of the invention may be practiced in a number of configurations beyond those shown and described, it is to be understood that the invention is not in any way limited by the exemplary embodiments, but is generally directed to a system and method for authoring and delivering online educational courses and is able to take numerous forms to do so without departing from the spirit and scope of the invention. It will also be appreciated by those skilled in the art that the present invention is not limited to the particular geometries and materials of construction disclosed, but may instead entail other functionally comparable structures or materials, now known or later developed, without departing from the spirit and scope of the invention. Furthermore, the various features of each of the above-described embodiments may be combined in any logical manner and are intended to be included within the scope of the present invention.

It should be understood that the logic code, programs, modules, processes, methods, and the order in which the respective elements of each method are performed are purely exemplary. Depending on the implementation, they may be performed in any order or in parallel, unless indicated otherwise in the present disclosure. Furthermore, the logic code is not related, or limited to any particular programming language, and may comprise one or more modules that execute on one or more processors in a distributed, non-distributed, or multiprocessing environment.

The method as described above may be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multi-chip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

1. A method for allowing a developer to author and deliver an online educational course, the method comprising the steps of:
implementing a central computing system configured for receiving and processing data related to the course along with data related to an at least one user;
using a computing device to provide the computing system with details related to a desired subject matter for which the course is to cover, a total duration of time allotted for the user to complete the course, and a minimum number of total points required for the user to receive a passing score upon completion of the course;
automatically generating a course structure and associated user interfaces based on said course-related details provided to the computing system, said course structure comprising an at least one instructional unit;
automatically generating an at least one learning activity for each instructional unit, each learning activity providing a focus section, an observation section, an experimentation section, an exploration section, a creation section, a sharing section, and an evaluation section, each section having a duration of time allotted for the user to complete said section and a maximum number of points to potentially be earned by the user for completing said section;
allowing the developer to populate the focus section of each of the at least one learning activity with content pertaining to information about key points of an at least one learning objective intended to be conveyed to the user through the associated learning activity, along with expected levels of proficiency and how performance is to be reported by the computing system;
allowing the developer to populate the observation section of each of the at least one learning activity with content pertaining to information designed to convey to the user the subject matter of the associated learning activity;
allowing the developer to populate the experimentation section of each of the at least one learning activity with content pertaining to self-assessment tools designed to test the user's understanding of the subject matter conveyed in the observation section and provide immediate feedback to ensure that proper understanding of said subject matter has been attained;
allowing the developer to populate the exploration section of each of the at least one learning activity with content pertaining to means by which the user may explore the Internet for further information related to the subject matter of the associated learning activity;
allowing the developer to populate the creation section of each of the at least one learning activity with content pertaining to means by which the user may create their own content in order to demonstrate their understanding of the subject matter of the associated learning activity;
allowing the developer to populate the sharing section of each of the at least one learning activity with content pertaining to means by which the user may share their created content with other users of the computing system;
allowing the developer to populate the evaluation section of each of the at least one learning activity with content pertaining to an examination designed to assess the user's degree of mastery of the subject matter of the associated learning activity; and
allowing the developer to selectively adjust the duration of time and points associated with each section of each learning activity.

2. The method of claim 1, further comprising the steps of:
using a computing device in communication with the computing system to set up a developer account associated with the developer; and
using a computing device in communication with the computing system to set up a user account associated with the at least one user.

3. The method of claim 1, further comprising the step of providing the computing system with desired developer-related information.

4. The method of claim 1, further comprising the step of providing the computing system with a course title for the course.

5. The method of claim 1, further comprising the step of allowing the developer to provide the computing system with a unit title for each of the at least one instructional unit.

6. The method of claim 1, further comprising the step of allowing the developer to provide the computing system with an at least one desired learning goal associated with each of the at least one instructional unit.

7. The method of claim 1, further comprising the step of allowing the developer to provide the computing system with a maximum number of points to potentially be earned by the user for completing each of the at least one instructional unit.

8. The method of claim 1, further comprising the step of allowing the developer to provide the computing system with a total duration of time allotted for the user to complete each of the at least one instructional unit.

9. (canceled)

10. The method of claim 1, further comprising the step of allowing the developer to create an at least one alternate learning activity for each of the at least one instructional unit, said alternate learning activity having a different degree of difficulty.

11. The method of claim 1, further comprising the step of allowing the developer to create an at least one alternate course structure within the course.

12. The method of claim 11, further comprising the step of allowing the user to choose a desired course structure to complete.

13. The method of claim 1, further comprising the step of allowing the developer to selectively set access permissions in order to limit the availability of the course to only those users whom the developer specifies.

14. The method of claim 13, further comprising the steps of:
generating a set of secure license keys for the course;
distributing the set of license keys to the at least one user designated by the developer to receive one of said license keys; and
allowing each designated user to log into the computing system, using a computing device in communication with the computing system, in order to complete the course.

15. The method of claim 1, further comprising the step of allowing the at least one user to log into the computing system, using a computing device in communication with the computing system, in order to complete the course.

16. The method of claim 15, further comprising the step of dynamically calculating the user's duration of time used and points earned.

17. The method of claim 16, further comprising the step of communicating to designated parties the user's duration of time used and points earned.

18. The method of claim 17, further comprising the step of transmitting reports regarding user access, grade transcripts and certificates to parties who have been designated to receive said information

19. A method for allowing a developer to author and deliver an online educational course, the method comprising the steps of:
implementing a central computing system configured for receiving and processing data related to the course along with data related to an at least one user;
using a computing device to provide the computing system with details related to a desired subject matter for which the course is to cover, a total duration of time allotted for the user to complete the course, and a minimum number of total points required for the user to receive a passing score upon completion of the course;
automatically generating a course structure and associated user interfaces based on said course-related details provided to the computing system, said course structure comprising an at least one instructional unit;
automatically generating an at least one learning activity for each instructional unit, each learning activity providing a focus section, an observation section, an experimentation section, an exploration section, a creation section, a sharing section, and an evaluation section, each section having a duration of time allotted for the user to complete said section and a maximum number of points to potentially be earned by the user for completing said section;
allowing the developer to selectively populate each section of each learning activity with content associated with the subject matter of the course;
allowing the developer to selectively adjust the duration of time and points associated with each section of each learning activity; and
upon the user completing the evaluation section associated with the at least one learning activity, awarding a progressively decreasing number of points based on the number of attempts the user required to successively complete said evaluation section;
whereby, the user is awarded a greater number of points for completing the evaluation section associated with the at least one learning activity on their first attempt as compared to subsequent attempts.

20. (canceled)
